(19) United States
(12) Patent Application Publication
(10) Pub. No.: US 2015/0336076 A1
(43) Pub. Date: Nov. 26, 2015

(54) Fuel treatment apparatus

(71) Applicants: Chi ZHANG, Cambridge (GB); Deli YANG, Beijing (CN); Xiaodong JIANG, Beijing (CN); Diqing SUN, Beijing (CN); Siqi ZHENG, Beijing (CN); Peng SHAN, Beijing (CN)

(72) Inventors: Deli YANG, Beijing (CN); Xiaodong JIANG, Beijing (CN); Diqing SUN, Beijing (CN); Siqi ZHENG, Beijing (CN); Peng SHAN, Beijing (CN)

(21) Appl. No.: 14/802,905

(22) Filed: Jul. 17, 2015

Related U.S. Application Data
(63) Continuation of application No. PCT/CN2014/071157, filed on Jan. 22, 2014.

(51) Int. Cl. B01J 19/12; B01J 19/08

(52) U.S. Cl. CPC B01J 19/123; B01J 19/087; B01J 2219/0854; B01J 2219/1203

(57) ABSTRACT

An apparatus for treating a fuel is disclosed. The apparatus comprises a channel for fuel to be treated, a photocatalyst situated within the channel so as to be in contact with the fuel passing therethrough, electromagnetic radiation source means for irradiating the catalyst and magnetic field source means for providing a magnetic field to which the fuel is exposed.

### CROSS-REFERENCE TO RELATED APPLICATIONS

This application is a U.S. National Stage application under 35 USC 371 of International Application PCT/CN2014/071157 (published as WO 2014/114243), filed Jan. 22, 2014 which claims priority to Chinese Application No.: 201320032343.7, filed Jan. 22, 2013. Benefit of the filing date of each of these prior applications is hereby claimed. Each of these prior applications is hereby incorporated by reference in its entirety.

### FIELD OF THE INVENTION

This invention relates to apparatus for treating a fuel, for example fuel oil, prior to combustion of the fuel.

### BACKGROUND TO THE INVENTION

The invention is particularly applicable to the treatment of hydrocarbon based fuel such as gasolene or diesel oil, prior to the consumption of the fuel in an internal combustion engine. However, the invention is also applicable to the treatment of fuels for other uses, for example for external combustion engines or boilers.

Calculations suggest that only about 38% of the chemical energy in a fuel supplied to an internal combustion engine is converted into mechanical output energy. This is partly due to the thermodynamic constraints that apply when high entropy thermal energy from burning fuel is converted into a mechanical output drive of the engine. However, the efficiency of the engine can be further reduced by inefficient combustion of the fuel. It is believed that, in fact, 33% of the energy in the fuel supplied to the engine is lost as exhaust loss, whilst 29% of the energy is lost as thermodynamic, or cooling loss.

A significant proportion of the exhaust losses is constituted by products of incomplete combustion, or products which have otherwise been detrimental to the burning process. Examples of either type of such product include carbon monoxide, hydrocarbons, nitrogen oxide, sulphur dioxide, smoke particles (certain heavy metal compounds, lead compounds, dark smoke and oil mists) and methanal. As well as being related to energy release, those products can be a source of environmental pollution. Thus effective reduction of the products in internal combustion engine combustion can boost fuel efficiency considerably and cut toxic emissions into the environment.

In general, previously proposed and used technologies for reducing harmful/incomplete internal combustion engine combustion products and boosting fuel-to-power efficiency either alter fuel molecular structures to boost combustion efficiency or raise oxygen density in the air that enters the engine so as to boost combustion efficiency.

Examples of the first category of technology include magnetic fuel economisers and nanofuel economisers, whilst rare earth oxygen boosters or turbochargers are examples of systems that raise oxygen density.

It has been proposed to use far infrared electromagnetic radiation to pretreat fuel. A far infrared radiator is installed on a fuel pipeline and generally emits electromagnetic radiation at 3-20 μm. The theory is that the energy from this radiation acts on the hydrocarbon molecules in the fuels causing resonance in the molecular bonds and absorption of the kinetic energy of the fire infrared photons. The absorption of energy is thought to cause transitions at the molecular and even atomic level, as a result of which saturated molecular chains in the fuels are forced to break and release free electrons to generate a large number of free radicals and enhance combustion efficiency. In practice, however, there is a body of evidence that suggests that almost none of these types of approach improves combustion of the fuels.

### SUMMARY OF THE INVENTION

According to a first aspect of the invention, there is provided apparatus for treating a fuel prior to combustion, the apparatus comprising a channel for fuel to be treated, a photocatalyst situated within the channel so as to be in contact with the fuel passing therethrough, electromagnetic radiation source means for irradiating the catalyst and magnetic field source means for providing a magnetic field to which the fuel is exposed. Preferably, the electromagnetic radiation source means is so arranged, relative to the channel, also to irradiate, in use, fuel travelling through the channel.

Preferably, the electromagnetic radiation source means is operable to emit electromagnetic radiation comprising ultraviolet light, preferably having a wave length in the range 175-400 nm.

Thus fuel oil being treated in the apparatus flows through a magnetic field in the channel while being catalised unter ultraviolet light by the photocatalyst. It is believed that during this process branched chains of macromolecules of fuel are broken up and photodecomposed whilst saturated molecular chains are opened up, releasing some ions and generating a large amount of free radicals. Alcohols and phenols in the fuel can also be reduced to hydrogen and hydroxyl ions, generating inorganic salts such as sulphide. It is thought that the inorganic salts generated above reduce the amount of negative burning products from the subsequent combustion of the fuel. The applicants also believe that the apparatus can both improve fuel quality and protect an engine supplied with the fuel. The fuel oil that has been photodecomposed by the apparatus delivers better antiknock performance and greater energy output. The fuel processed by the apparatus may also dampen engine noise and undermine modular stability of poor quality fuel oil. Some impurities are mineralised to inorganic salts that are emitted naturally, without participating in any of the combustion reactions. The apparatus is thought to be particularly significant in photodecomposing methanol and other substances that can damage a three way catalytic converter on an automobile, and thus reducing the chance of the converter being damaged by pollutants from the burnt fuel. The problem of frequent engine damage caused by poor quality fuel oil that contains ethanol is also greatly reduced or obviated.

It is believed that the apparatus produces fuel that, when consumed in an engine, produces greater and more intensive energy of external combustion, due to an increased burning rate, thus enabling the engine to develop greater torque at lower rotating speeds as well as improved power (possibly by up to 10%).

Tests show that gasolene that has been processed by the apparatus, when consumed in a spark combustion engine, emits 45% less CO, 7.2% less NxO and 25% less HC, and generates fewer PM 2.5 size range particles (i.e. smaller than 2.5 micrometers).

The fuel oil processed by the apparatus may also be useful in clearing up carbon deposition in engine cylinders, whilst a greater combustion efficiency of the fuel helps with the dissolution of coke deposits.

In the case of carbon based fuel, for example oil, diesel or gasolene, the 175-253.7 nm ultraviolet light has been found to decompose organic molecules, whilst the ultraviolet light of the wavelength 253.7-380 nm has been found to activate the photocatalyst, thereby releasing reactive oxygen and hydroxyl ions.

The electromagnetic radiation source means may, for example, comprise a mercury vapour gas discharge lamp, an excimer laser, an LED (light emitting diode) or an array of LEDs. In any case, the electromagnetic radiation source means preferably extends along the channel and preferably along its whole length.

This facilitates an arrangement in which the treatment of the fuel by the electromagnetic radiation occurs at least for substantially the whole time that the fuel is travelling through the channel. Preferably, the channel encircles the electgromagnetic radiation source means.

Preferably, the magnetic field source means is so arranged, relative to the channel, that the magnetic field from the magnetic field source means extends into the channel.

Thus fuel in the channel is simultaneously treated by the magnetic field, the electromagnetic radiation and the photocatalyst. The magnetic field source means may to advantage be situated outside the channel. Preferably, the magnetic field source means encircles the channel.

The magnetic field source means may comprise one or more permanent magnets, but preferably comprises an electromagnetic coil which encircles the channel.

The use of an electromagnetic coil as the source of magnetic field enables a time varying magnetic field to be readily generated, and it is believed that this can result in the fuel being more effectively treated.

To that end, the electromagnetic coil may to advantage be connected to coil driver circuitry operable to supply a time varying current to the coil, the current being in the form of a square wave signal having a frequency of 100-500 Hz.

Preferably the square wave current generated by the driver circuitry flows in alternating senses around the coil.

It is believed that the magnetic fields generated by such a current will have a beneficial stirring effect on hydrocarbon fuel molecules being treated in the apparatus.

The electromagnetic coil may to advantage be one of two such coils, which are preferably coaxial, the arrangement of coils and driving circuitry being such that current flowing through the coils at any one time travels in opposite senses around the coils. For example, while the current is flowing in a clockwise direction through the first coil, the current in the second coil, when viewed in the same direction as the first coil, will be flowing in an anticlockwise direction.

Preferably, the coils are wound in opposite senses. This enables these current flow characteristics to be achieved simply by connecting the coils in series to the output from the coil driver circuitry.

Preferably, the apparatus includes an electrically conductive member which extends into the channel and which, in use, conducts an electric current.

This current causes a magnetic field which is believed to assist in the separation of minerals from the fuel and/or to vary the direction and/or magnitude of the net flux of magnetic field within the channel.

Preferably, the conductive member is so arranged that said current is induced by the magnetic field generated in the channel by the magnetic field generating means.

Preferably, the conductive member is helical and is preferably substantially coaxial with the coils.

The helical member is preferably rotatably mounted, for rotation about its axis within the channel, the apparatus including rotational drive means for rotating the helical member.

The rotational drive means may conveniently include a motor which drives the helical member through a magnetic linkage comprising a first coupling member outside the channel and a second coupling member carried on the helical member, the coupling members being magnetically coupled to each other so that rotation of the first coupling member by the motor results in a corresponding rotation of the second coupling member.

Preferably, the first coupling member comprises a gear ring which encircles the channel and meshes with an output gear attached to the motor.

The photocatalyst may conveniently comprise a coating on the inner surface of the channel.

Additionally, or alternatively, the photocatalyst may be carried by a rack within the channel, the rack being attached to the helical member.

The apparatus may to advantage include a cleaning member situated within the channel in contact with the electromagnetic radiation source means, the cleaning member being movable relative to the electromagnetic radiation source means to clean the latter.

The cleaning member may conveniently be constituted by the helical member or the rack. Preferably, the photocatalyst comprises titanium dioxide.

According to a second aspect of the invention, there is provided a device designed to improve ICE fuel effeciency via magnetic force, photocatalysts and photodecomposition. The device having a main body which defines a photocatalyst channel which is located in a magnetic field and stationed on the fuel pipeline for the ICE along which pipeline fuel is transported to the ICE, the channel also encircling a light source which radiates electromagnetic radiation at a wavelength of 175-400 nm, the device further comprising photocatalysts situated in the channel and a magnetic field generator on the outer side of the channel operable to expose the channel to magnetic field, the channel having an inlet and outlet which have both connected to the fuel pipeline and sealed.

Preferably, the device further comprises spirals (or a helical member) that are used to even out magnetic distribution and are deployed in the photocatalyst channel.

Preferably, the photocatalyst channel is circular, spiral or bulbous.

Preferably, the light source is a source of nano light or black light.

Preferably, the photocatalysts are located on the inner wall of the photocatalyst channel, towards which walls the light source radiates.

Preferably, the photocatalysts are located inside the photocatalyst channel, or are located both inside the channel and on an inner wall of the channel to which the light source radiates.

Preferably, the photocatalysts are formed as coatings containing titanium dioxide on the inner wall of the photocatalyst channel, or are cylindrical racks containing titanium dioxide when located inside the channel.

Preferably, the magnetic field generator is a permanent magnet, or the magnetic field is an electromagnetic field.

Preferably, the helical members (spirals) that are used to even out magnetic distribution consist of 1-2 parallel iron plates clad in a thin aluminium sheet and formed or moulded into a spiral/helical shape.

### BRIEF DESCRIPTION OF THE DRAWINGS

The invention will now be described, by way of example only, with reference to the accompanying drawings in which:

FIG. 1 is a cross-sectional view of a first embodiment of apparatus in accordance with the invention;

FIG. 2 is an isometric view of a rack which supports a photocatalyst, and which forms part of the apparatus shown in FIG. 1;

FIG. 3 is a side elevation of a helical member, also forming part of the apparatus shown in FIG. 1;

FIG. 4 is a sectional side view of a second embodiment of apparatus in accordance with the invention;

FIG. 5 is a sectional side view of a third embodiment of apparatus in accordance with the invention;

FIG. 6 is a circuit diagram showing the circuitry that controls the operation of the third embodiment and also supplies the energising current for electromagnetic coils on the third embodiment; and

FIG. 7 is a circuit diagram of circuitry for powering the electric motor and the lamp of the third embodiment of apparatus.

### DETAILED DESCRIPTION

Each embodiment of apparatus comprises a device which is intended to improve ICE (internal combination engine) fuel combustion efficiency through magnetic force, photo catalysts and photo-decomposition. It allows fuels to be processed concurrently through a magnetic field, a light source and photo catalysts, before the fuel is fed into the engine cylinder for a complete combustion. It is believed to have the benefits of lowering carbon emissions, mitigating environmental pollution and improving engine efficiency.

The device mainly consists of a photo catalyst channel. The channel is located to a magnetic field and stationed on the fuel pipeline, transporting fuels from one end of the pipeline to the other. It also encircles electromagnetic radiation sourse means comprising a light source which radiates electromagnetic radiation at wavelength of 175-400 nm. Photo catalysts are deployed in the channel. There is a magnetic field generator on the outer side of the channel to expose the channel to the magnetic field. The inlet and outlet of the channel are both connected to the fuel pipeline and sealed. Spirals that are used to even out magnetic distribution are deployed in the described photo catalyst channel. The described photo catalyst channel is circular, spiral, or bulbous. Nano light or black light are terms used to describe the emissions from the 175-400 nm light source. The photo catalysts are located on the inner wall of the channel towards which the light source radiates. The photo catalysts may also be located inside the photo catalyst channel, or located both inside the channel and on the inner wall of the channel towards which the light source radiates. The photo catalysts are coatings containing titanium dioxide when located on the inner wall of the photo catalyst channel. The photo catalysts are also on cylindrical racks containing titanium dioxide when located inside the channel. The magnetic field is generated by a permanent magnet, or is an electromagnetic field. The spirals that are used to even out magnetic distribution consist of 1-2 paralleled iron plates. The pair of plates are clad in a thin aluminium sheet and molded into a spiral shape, to constitute a helical member.

The embodiments allow fuels to be processed concurrently through a magnetic field, a light source and photo catalysts, before being fed into the engine cylinder for a complete combustion. They can reduce carbon emissions, mitigate environmental pollution and improve engine efficiency.

The fuels can be concurrently exposed to a magnetic field, a 175-400 nm light source, and photo catalysts before being fed into the engine for deflagration. The magnetic field, the 175-400 nm light source and photo catalysts act on the fuels at the same time.

ICE fuels generally refer to organic liquids like petrol, diesel, kerosene, ethanol, gasoline and methanol, and organic gases like liquefied gas, natural gas and alcohol. They are mainly a mix of organic compounds, for instance, alkanes, aromatic hydrocarbons, benzene and hydroxyl. All the fuels are organic mixtures with long carbon chains and heavy molecules. The heavier the molecules are, the stickier they are; the lighter the molecules are, the higher heat value they contain and the better is their atomization combustion. Hydroxyl free radicals are high energy fuels. Modern combustion theories suggest oxidation of organic compounds is in nature a series of chain reactions by free radicals. The speed of combustion and the generation of negative burning products are affected by the status of molecular chains that free radicals polymerize into. The length of molecular chains of organic compounds dictates the level of energy in combustion reactions. Compounds like phenol and alcohol can decompose into hydric and hydroxyl ions that propel combustion. Organic fuels free from metal ions burn faster and fuller. It is difficult for inorganic salts to generate oxides that pollute the environment. Fuels going through a magnetic field are catalysed and oxidised. Fuel gas molecular chains break and release hydroxyl free radicals. Thiol and thiophene in the radicals decompose into hydrogen and generate a large amount of free radicals and hydrogen. When free radicals polymerize, the Brownian motion—which drives polymer molecular motions—turns into a hollow tubular motion which accelerates the combustion speed. In the meantime, the photo catalysts in the fuels of this utility model are exposed to 175-400 nm light waves. The catalysts absorb energy from the light and form electron-hole pairs. Those pairs (photo carriers) quickly move to the surface and activate H₂O and O₂ attached to the surface. Hydroxyl (—OH) and Reactive oxygen (—O) are then generated to speed up combustion. Petrol has a combustion value of 10,500 kcal/litre while hydrogen has that of 20,000 kcal/litre. Hydrogen only requires a small amount of energy to ignite, at ⅙ of what petrol requires. The travel speed of flames in burning hydrogen is nine times as fast as that in burning petrol. The addition of hydrogen to fuels accelerates the speed of flames and enhances the energy release base of heat values. Hybrid gas then ignites more quickly and burns faster to avoid energy waste and negative reactants generated from fire accidents. Inorganic salts generated can reduce the generation of oxides and save energy while cutting pollution.

Without changing the ICE structural designs, each embodiment enhances energy release base, speeds up fuel combustion, and bends the burning curve to complete the energy release process in an earlier and intensified manner in the meantime, inorganic compounds like sulphides are turned into salts in the process and environmental pollution is thus mitigated. Experiments suggest that application of this solution bends burning curves and completes the energy release process in an earlier and intensified manner. Engine noise is significantly dampened and torque is greatly enhanced. Engine efficiency is considerably boosted and negative burning products are effectively reduced.

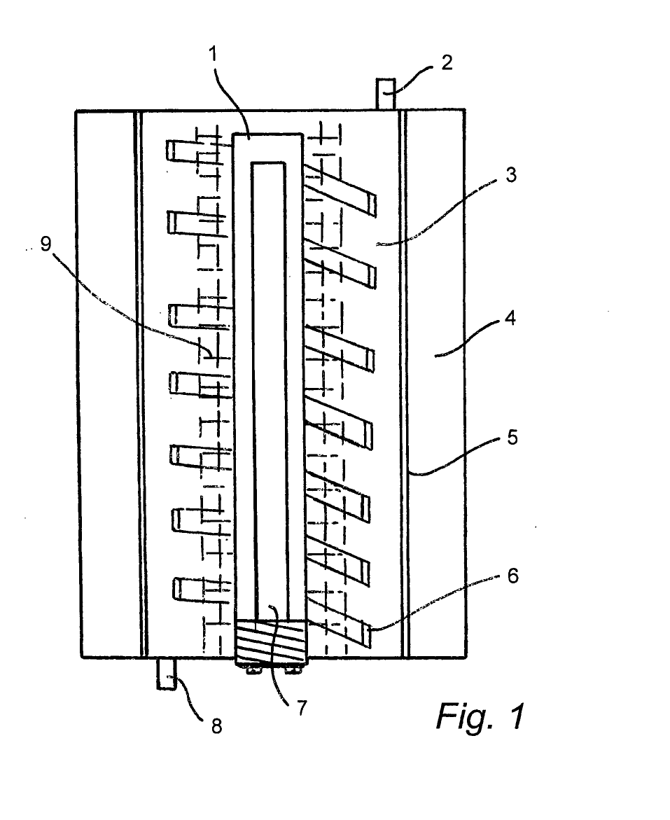

FIGS. 1-4 illustrate a device designed to improve ICE fuel combustion efficiency through magnet force, photo catalysts and photo-decomposition. The device mainly consists of a photo catalyst channel 3 in which in use, fuel is concurrently exposed to a magnetic field, a 175-400 nm light source, and photo catalysts before being fed into an engine for deflagration.

The photo catalyst channel is located in a magnetic field and stationed on the fuel pipeline, transporting fuels from one end of the pipeline to the other. It also encircles a light source which radiates at 175-400 nm. Photo catalysts are deployed in the channel 3. There is a magnetic field generator 4 on the outer side of the channel 3 to expose the channel 3 to the magnetic field. The inlet 8 and outlet 2 of the channel 3 are both connected to the fuel pipeline and sealed.

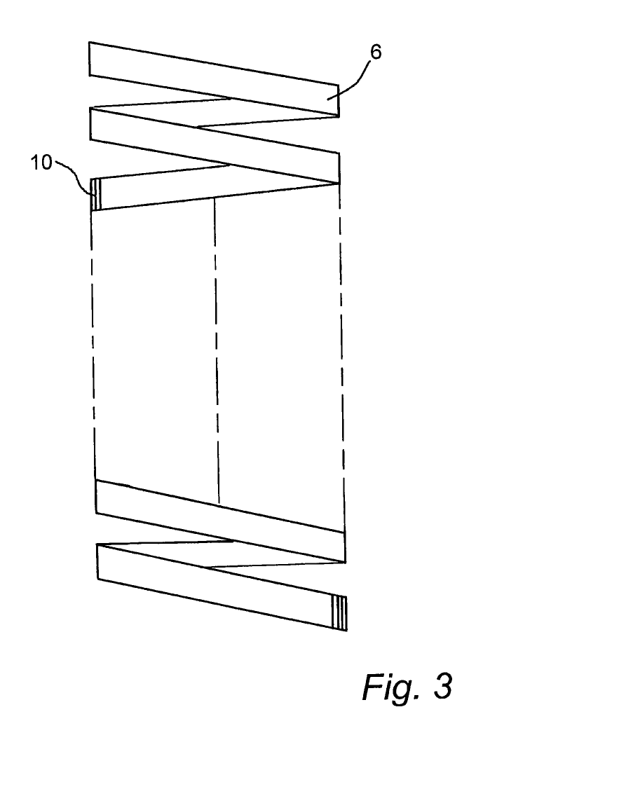

With reference to FIG. 3, spirals constituting a helical member 6 are used to even out magnetic distribution and are deployed in the photo catalyst channel 3. Those spirals are formed from two parallel iron plates 10. The pair of plates 10 are clad in a thin aluminium sheet and molded into a spiral shape. They play a role of evenly distributing the magnetic field in the catalyst channel, and facilitate catalysis and oxidation of fuel in the channel 3 under the magnetic force.

The described catalyst channel is cylindrical, but in other embodiments may be circular, spiral, or bulbous. Nano light or black light is the electromagnetic radiation emitted by 175-400 nm light source 7. The described photo catalysts are located on the inner wall of the channel 3 towards which the light source 7 radiates, and are also provided inside the photo catalyst channel 3. More specifically, the photo catalysts are included in coating 5 containing titanium dioxide on the inner wall of the photo catalyst channel 3. The photo catalysts are also applied to a cylindrical rack 9 containing titanium dioxide when located inside the channel.

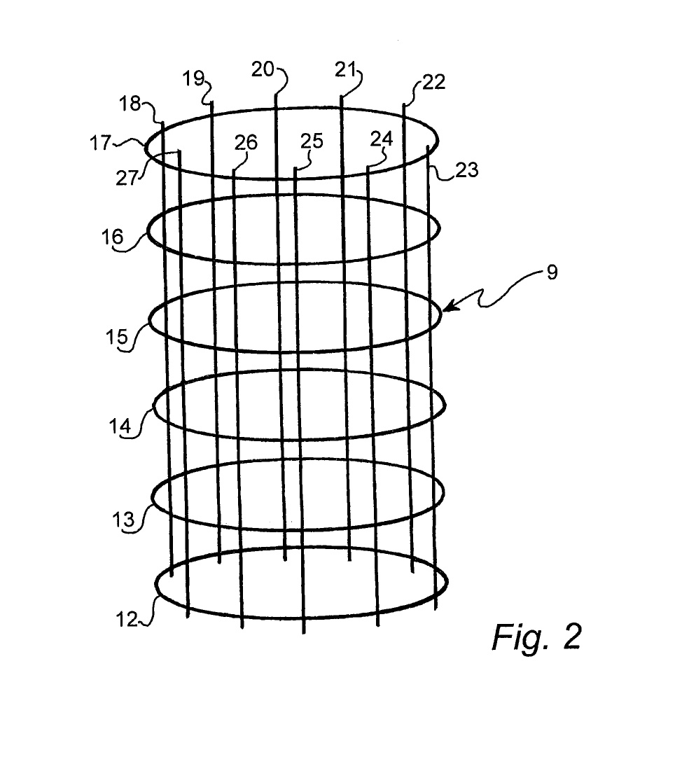

As shown in FIG. 1, the photo catalyst channel 3 encircles the light source 7 and allows fuels to flow through. A transparent circular shield is centrally housed in the channel 3 and corresponds to the shape of the light source. The shield defines a chamber 1 which accommodates the light source at the center of the transparent circular shield. The inner wall of the channel 3 has coatings containing titanium dioxide 5. Inside the channel 3, the cylindrical rack 9 carrying titanium dioxide is installed. With reference to FIG. 2, the titanium dioxide is applied as a coating to the outer surface of the cylindrical rack 9. This is to extend the interface where fuels meet photo catalysts for conversation. Reflective coatings can be applied to the outer surface of the transparent channel 3 to a magnetic generator 4 (which encircles the channel 3) to allow both direct and reflected light to act on the fuels flowing through the channel. The photo-decomposition results will then be enhanced. The transparent shield is made of heatproof transparent materials, for example, heatproof glass.

With reference to FIG. 2, the rack 9 is generally cylindrical, and is formed from six coaxial rings 12-17 which are parallel and are spaced apart in the direction of the axis of the cylinder defined by the rack 9. The rings are held together by means of straight, parallel tie bars 18-27 which extend parallel to the axis of the cylinder defined by the rack 9. The tie bars 18-27 and rings can be formed of a wire of a suitable metal, and the tie bars and rings can be held together by any suitable means, for example by being welded together. The whole of the rack 9 is coated with the titanium dark side photo catalyst. The tie bars 18-27 are regularly arranged around the rings so that the angular spacing between any adjacent pair of tie bars is constant.

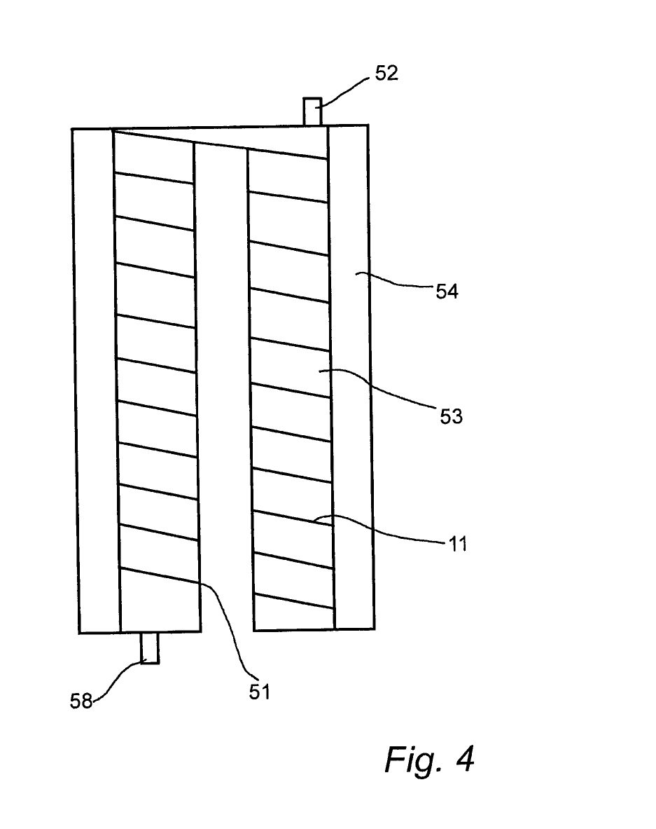

In the embodiment shown in FIG. 4, various components correspond to the components of the first embodiment, and these are indicated by the reference numerals of FIGS. 1-3 raised by 50. In FIG. 4, the light source and rack have been omitted for the sake of clarity. The second embodiment does not have a component corresponding to the helical member 6, but instead includes a helical arrangement of vanes 11 which define a helical path between the inlet 52 and outlet 58.

Thus the channel which encircles the light source and allows fuels to flow through is a spiral channel surrounding the light source. Spiral vanes or separators 11 are positioned in the transparent circular shield, to form a spiral channel where fuels can only enter from the inlet sitting at the top, and then flow to the shape of the spiral channel, before finally heading for the outlet at the bottom. This type of channel helps prolong contacts between magnetic, light, photo catalyst materials and fuels to extend conversion time. Coatings with titanium dioxide are applied to the inner wall of the spiral channel. Cylindrical racks are installed within the channel (between the shield 1 and radial inner edges of vanes 11).

In either embodiment the magnetic field is generated by a magnetic generator (4, 54). The generator can be either a permanent magnet or an electromagnetic generator as the latter also generates a magnetic field. In these examples the field provided by magnet-field-generating coils driven by electric controllers which feature positive and negative square wave generators, power amplifiers and voltage stabilizers. Car batteries charge the controllers, and when electricity runs through the positive square wave generators, positive and negative square waves at 100-500 Hz are generated. After being amplified by the power amplifiers, the waves are fed into the magnet-field-generating coils and a magnetic field occurs within the coils. The power source provides electricity via voltage stabilisers to the light source in the transparent shield. Positive square wave generators, power amplifiers and voltage stabilisers are all available from the market. They can be replaced by traditional circuits, but it is preferable for the circuits used to have positive square wave generators that generate 100-500 Hz positive and negative square waves. After being amplified by power amplifiers and fed into the magnet-field-generating coils, the waves can generate magnetic force equivalent to a magnetic flux density of 100-500 Gs. The magnetic generator sits on the outer side the photo catalyst channel, and the catalyst channel sits in the magnetic field generated by the generator.

A programmed unit can also provide the light source and magnetic generator of this utility model with conversion-support power circuits, just like storage batteries. The unit controls the light source and generates a modulated magnetic field. An electromagnetic generator can also generate a modulated magnetic field. Such a field is formed of magnet-field-generating coils. Car storage batteries produce 100-500 Hz positive and negative square waves via the programmed unit, and feed them into magnet-field-generating coils. A modulated magnetic field is then induced in the coils. The power source provides electricity via the programmed unit to the light source in the transparent shield. Program-controlled IC circuit components of the programmed unit are all available from the market, therefore no such details will be repeated. The magnetic generator sits on the outer side the photo catalyst channel, and the catalyst channel sits in the modulated magnetic field generated by the generator.

Each embodiment is for installation near the engine fuel inlet and would be mounted on the corresponding engine or vehicle and connected to the car storage batteries to help magnet-field-generating coils generate the magnetic field. Through the inlet, fuels first enter the photo catalyst channel that encircles the light source and conveys fuels. The fuels are concurrently exposed to the magnetic field, the 175-400 nm light source and the photo catalysts, before feeding into the engine for deflagration, to achieve better engine efficiency and fuel savings.

A device in accordance with the invention allows fuels to be processed concurrently through a magnetic field, a light source and photo catalysts, before being fed into the engine cylinder for a complete combustion. It has the benefits of reducing carbon emissions, mitigating environmental pollution and improving engine efficiency.

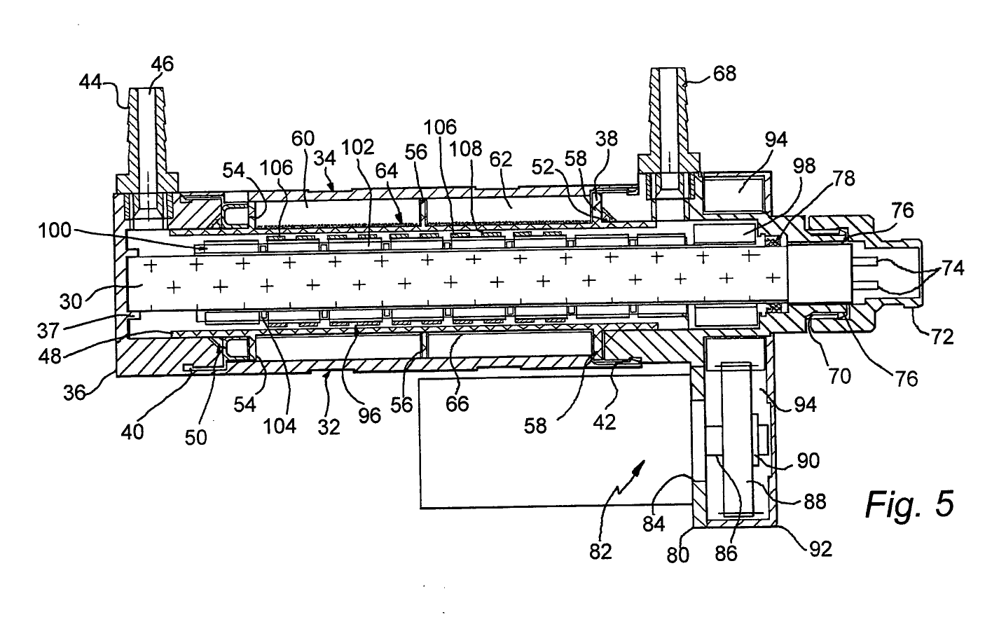

The third embodiment of apparatus in accordance with the invention will now be described with reference to FIGS. 5-7. In this case, an elongate, low pressure mercury discharge lamp 30 is contained within a hollow cylindrical housing 32 which is formed from metal or any other suitable material and is of a three part construction, having a cylindrical body portion 34 attached at either end to two end caps 36 and 38 attached to the body at screw threaded connectors 40 and 42 provided between the body and each end cap.

The cap 36 carries a hose connector 44 which acts as the inlet for the apparatus. The connector 44 is attached to the cap by any suitable means, and sealed thereto, again by any suitable means. The connector 44 defined one end of a passage 46 which extends through the cap 36 and into the interior of the housing 32.

The housing 32 accommodates a hollow cylindrical core piece which is coaxial with the housing 32 and light source 30 and extends along the housing from the end cap 36 to the end cap 38. The core piece 38 is formed from a non-ferromagnetic material, and is attached to the housing 32 at the caps 36 and 38 by any suitable means, for example a screw threaded connector or by being welded.

A liquid tight seal between the core piece 48 and the end caps 36 and 38 is provided by O ring seals 50 and 52. The cap 36 includes a cylindrical end wall 37 which defines a blind socket for locating the adjacent end of the lamp 30.

The core 48 includes three outwardly directed annular flanges 54, 56 and 58 which define, with the portion 34 of the housing 32, a pair of axially spaced cylindrical racks 60 and 62 which are coaxial with the core 48 and the lamp 30, and which accommodate corresponding coaxial coils 64 and 66, each of which is wound onto a respective one of the racks 60 and 62.

The coils 64 and 66 are of a suitable conductor, and act as electromagnetic coils. The coils have the same number of turns as each other, but are wound onto the rack 60 and rack 62 in opposite senses and are connected to driving circuitry in series with each other, so that the current from the driving circuitry passes through the coils in opposite senses. The core 54 thus acts as a rack for supporting the coils 64 and 66.

The end cap 38 includes an outlet hose connector 68 through which fuel exits the apparatus after having been processed.

The outboard end of the cap 38 includes a screw threaded connector 70 on which a further end cap 72 is mounted. As can be seen from FIG. 5, the cap 72 is open ended to allow access to terminals 74 of the lamp 30. Leakage of fuel between the lamp 30 and the cap 72 is prevented by an annular O ring seal 76. A further, upstream annular O ring seal 78 is also provided between the main body of the lamp 30 and the cap 38, and also helps to prevent leakage of oil out of the cap 38.

The cap 48 is also provided with a mounting lug 80 which is generally circular (when viewed end on) and via which a DC electric motor 82 is attached to the apparatus. The lug 80 has an aperture 84 through which the motor extends, the motor having an output shaft 86 which extends to the opposite side of the lug 80 from the rest of the motor, and which is attached to an externally toothed gear wheel 88 held on the shaft 86 by a fastening nut 90. A part cylindrical cowell 92 defines, with the lug 80, a cylindrical chamber 94 for accommodating the gear wheel 88.

The chamber 92 is open at its upper region, with the apparatus viewed as shown in FIG. 5, so that the gear wheel 88 can mesh with an externally toothed annular ring 94 which is rotatably mounted on the cap 38, is disposed coaxially with the lamp 30 and core 48 and provides the first magnetic coupling member of a magnetic linkage through which the motor 82 can rotate a rack and helical member assembly 96 around the lamp 30.

To that end, the annular ring 94 contains a number of radially positioned permanent magnets (not shown) which are equi-angularly arranged within the ring with alternating polarities. Thus, for example, one of those magnets positioned with the north pole as its radially inner pole will be flanked by two other magnets in each of which the south pole will be radially innermost. The second coupling member of the magnetic linkage comprises an inner annular ring 98 which contains a similar arrangement of magnets (not shown), and is mounted within the housing 32. In use, the operation of the motor 82 rotates the gear wheel 88 which, in turn, rotates the ring 94. This, in turn, causes a corresponding rotation of the ring 98, by virtue of the magnetic coupling between the rings, so that drive can be transmitted to the ring 98 without the need for a transmission which directly contacts the ring 98.

The rack and helical member assembly extends along a substantial portion of the length of the interior of the housing 32, and comprises a rack 100 which is attached at one end to the ring 98, bears against the lamp 30 and is also rotatable about the lamp 30. The general structure of the rack is similar in many respects to the rack shown in FIG. 2. Thus the rack 100 has eight coaxial rings (for example ring 102). In this case, however, each of these rings is generally cylindrical. Instead of the tie bars of the FIG. 2 rack, each of the rings is attached to its neighbouring rings through a number of equi-angularly spaced, blade like connectors such as the connector 104 which also bears against the lamp 30. Each of these connectors bears against the lamp 30 so that, as the rack 100 rotates about the lamp 30, it cleans the surface of the latter. The rings, such as ring 102, of the rack 100 can also have a cleaning effect during this rotation. A helical member 106, formed from silicon steel sheet that has been cut and shaped into a helical form, is attached to the rack 100 at the outer surfaces of a number of its rings, and is thus also arranged coaxially with the rings, and hence with the lamp 30 and housing 32.

Titanium dioxide catalyst may also be coated on the exposed outer surfaces of the rings of the rack 100, but in this particular case, the titanium dioxide photo catalyst is applied just as a coating 108 to the inner surface of the core 48.

As can be seen from FIG. 5, the spacing between the coating 108 and the radial outer faces of the helical member 106, the exposed portions of the rack 100 and the exposed portions of the lamp (i.e. those not covered by the rack at any one time) provide a channel through which fuel introduced through the connector 44 can flow through the apparatus and exit through the connector 68.

During its passage through the apparatus, the fuel is exposed to ultra violet radiation from the lamp 30, to the magnetic field generated by the coils 64 and 66 and to the photo catalyst coating 108 which is activated by the light from the lamp 30. In addition, the magnetic field generated by the coils 64 and 66 induces in the helical member 106 a current which itself creates a magnetic field. It is believed that the magnetic field to which the fuel is subjected helps to separate mineral components so that these do not interfere with the subsequent combustion process. During the operation of the device, the motor 82 rotates the rack 100 and helical member 106. This rotation is believed to assist in the processing of the fuel, and causes the rack 100 to clean the outer surface of the lamp 30, as discussed above.

The lamp 30 has a power output of between 8 watts and 14 watts in the current models (higher power output lamp can also be adopted), and is of a length between 10 and 20 cm in the current model. The actual power output and dimensions of the lamp (and the associated dimensions of the rest of the apparatus) may differ from one embodiment to the next, depending upon the nature of the fuel to be processed, and the size of engine to which the processed fuel is to be supplied.

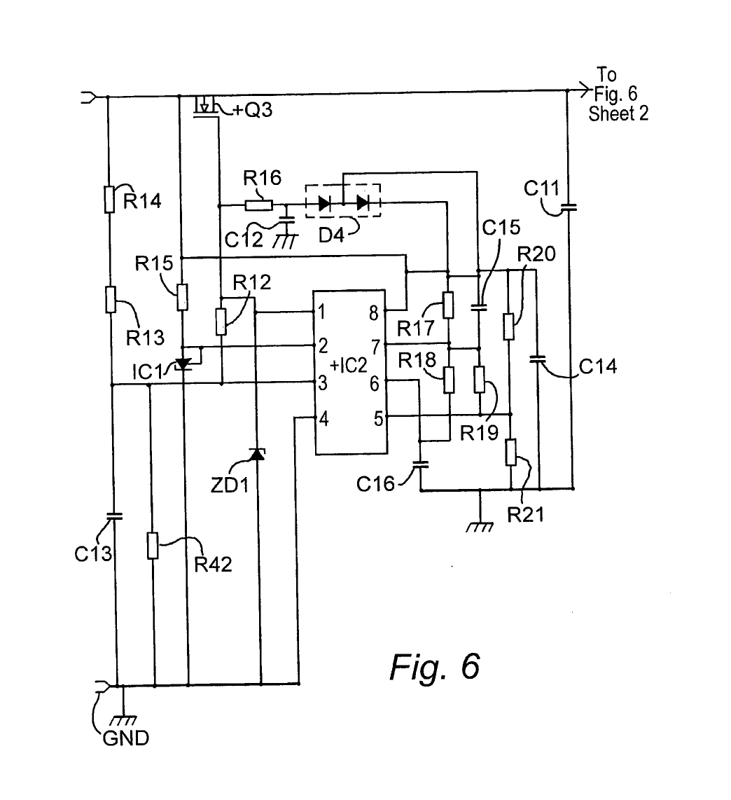

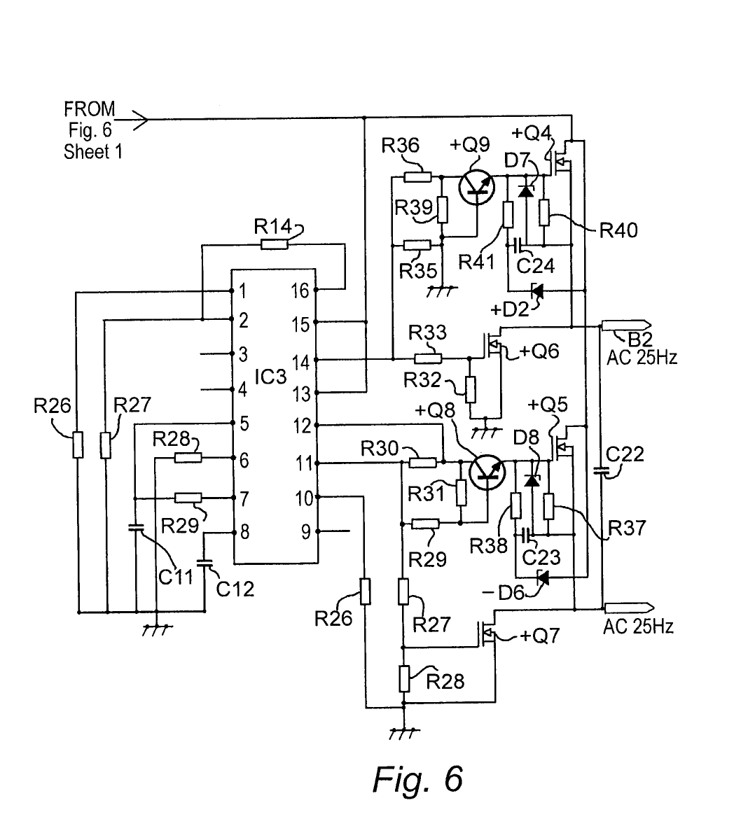

In use, the coils 64 and 66 are supplied with an alternating square wave current of a frequency of 100-500 Hz (as with the apparatus of the first embodiment). This current is supplied by the circuit shown in FIG. 6. That circuit is based around two integrated circuits, IC2 and IC3. Integrated circuit IC2 may be of the type designated by the reference MM358 8-DIP, whilst IC3 may be of the type designated by the reference LM2525A16-DIP.

The circuit shown in FIG. 6 includes an input for receiving a signal indicative of the activation of the engine, and is arranged so that the activation of the engine will automatically trigger the circuit of FIG. 6 into activating the lamp 30 and the motor 82, as well as triggering the supply of the energising current to the coils 64 and 66.

The skilled addressee will appreciate the system to which the input needs to be connected to achieve this, but an example would be the vehicle's fuel pump control system.

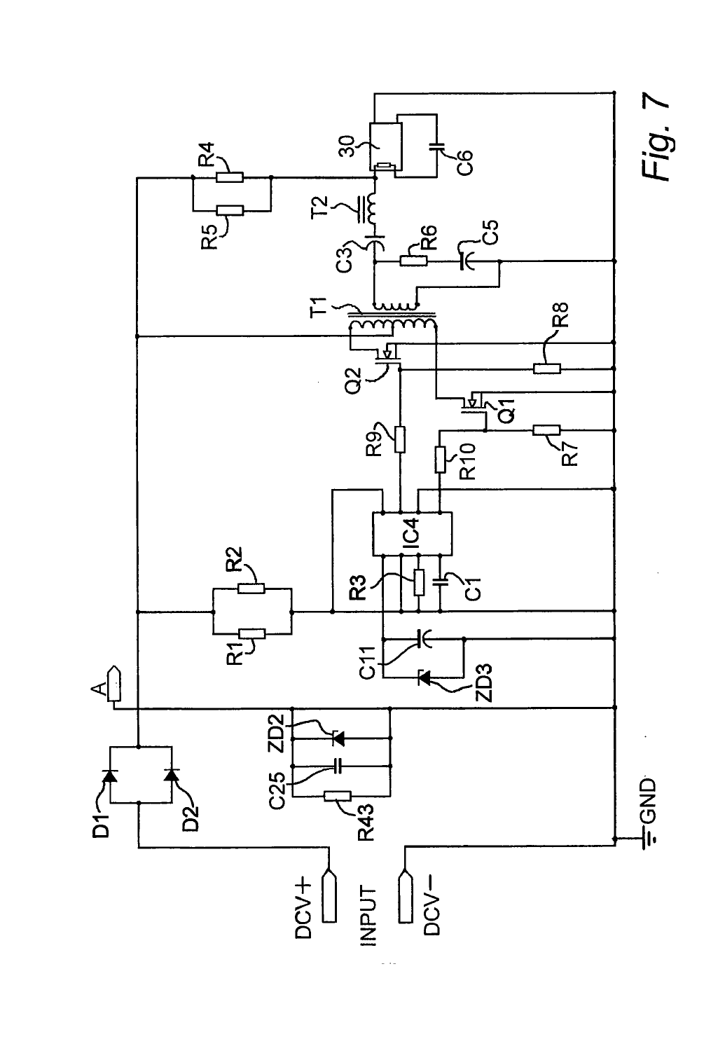

The input on the circuit of FIG. 6 for the activation signal is the input A, in the top left hand corner, via which the circuit of FIG. 6 is connected to the input A of the circuit of FIG. 7. The circuit of FIG. 7 includes DC V+ and DC V− terminals which receive the signal indicative of activation, causing the circuit of FIG. 7 to provide an activation signal at the input A of the FIG. 6 circuit.

The output for the alternating current for energising the coils 64 and 66 is provided by terminals B2-AC 25 Hz and AC 25 Hz on the right hand size of the circuit.

The circuit shown in FIG. 6 includes a terminal A which is connected to terminal A of the circuit of FIG. 7. The circuit of FIG. 7 is based around integrated circuit IC4, which may be of the type designated by the reference IR2520D FIG. 8 PIN. When power is received to the terminal A of the circuit of FIG. 7, the latter starts up and then drives the lamp 30 by causing the latter to emit ultraviolet radiation as described above.

The table Annexed to this description sets out the details of various components of the circuits.

It will be appreciated that there are other ways of activating and driving the lamp 30, the motor 82 and the coils 64 and 66, and suitable circuits for achieving this will be readily apparent to the skilled addressee.

We claim:

1. An apparatus for treating a fuel prior to combustion, the apparatus comprising:
a channel for the fuel to be treated;
a photocatalyst situated within the channel so as to be in contact with the fuel passing therethrough,
electromagnetic radiation source means for irradiating the catalyst; and
magnetic field source means for providing a magnetic field to which the fuel is exposed.

2. The apparatus according to claim 1, wherein the electromagnetic radiation source means is so arranged, relative to the channel, to irradiate, in use, fuel travelling through the channel.

3. The apparatus according to claim 1, wherein the electromagnetic radiation source means is operable to emit electromagnetic, radiation comprising ultraviolet light.

4. The apparatus according to claim 3, wherein said ultraviolet light has a wave length in a range of 175-400 nm.

5. The apparatus according to claim 1, wherein the electromagnetic radiation source means comprises a mercury vapour gas discharge lamp, an excimer laser, an LED (light emitting diode) or an array of LEDs.

6. The apparatus according to claim 1, wherein the electromagnetic radiation source means extends along the channel.

7. The apparatus according to claim 6, wherein the electromagnetic radiation source means extends along the whole length of the channel.

8. The apparatus according to claim 1, wherein the channel encircles the electromagnetic radiation source means.

9. The apparatus according to claim 1, wherein the magnetic field source means is so arranged, relative to the channel, that the magnetic field from the magnetic field source means extends into the channel.

10. The apparatus according to claim 1, wherein the magnetic field source means comprises an electromagnetic coil which encircles the channel.

11. The apparatus according to claim 10, wherein the electromagnetic coil is connected to coil driver circuitry operable to supply a time varying current to the coil, the current being in the form of a square wave signal having a frequency of 100-500 Hz

12. The apparatus according to claim 11, wherein the square wave current generated by the driver circuitry flows in alternating senses around the coil.

13. The apparatus according to claim 1, wherein the apparatus includes an electrically conductive member which extends into the channel and which in use, conducts an electric current.

14. The apparatus according to claim 13, wherein the conductive member is so arranged that said current is induced by the magnetic field generated in the channel by the magnetic field generating means.

15. The apparatus according to claim 13, wherein the conductive member is helical and is substantially coaxial with the coils.

16. The apparatus according to any of claims 13, wherein the helical member is rotatably mounted, for rotation about its axis within the channel, the The apparatus including rotational drive means for rotating the electrically conductive member.

17. The apparatus according to claim 16, wherein the rotational drive means may conveniently include a motor which drives the helical member through a magnetic linkage comprising a first coupling member outside the channel and a second coupling member attached to an electrically conductive member, the coupling members being magnetically coupled to each other so that rotation of the first coupling member by the motor results in a corresponding rotation of the second coupling member.

18. The apparatus according to claim 1, wherein the photocatalyst comprises a coating on the inner surface of the channel.

19. The apparatus according to claim 1, wherein the apparatus includes a cleaning member situated within the channel in contact with the electromagnetic radiation source means, the cleaning member being movable relative to the electromagnetic radiation source means to clean the latter.

20. The apparatus according to claim 1, wherein the photocatalyst comprises titanium dioxide.
